(19) United States
(12) Patent Application Publication
(10) Pub. No.: US 2020/0064520 A1
(43) Pub. Date: Feb. 27, 2020

(54) SMART MULTIFUNCTIONAL LENS COATINGS

(71) Applicant: GM Global Technology Operations LLC, Detroit, MI (US)

(72) Inventors: Xingcheng Xiao, Troy, MI (US); Xiaosong Huang, Novi, MI (US); Jinsong Wang, Troy, MI (US); Qingrong Zhao, Madison Heights, MI (US)

(73) Assignee: GM Global Technology Operations LLC, Detroit, MI (US)

(21) Appl. No.: 16/108,850

(22) Filed: Aug. 22, 2018

(51) Int. Cl. G02B 1/18; G02B 6/12; B32B 9/00; B32B 27/28

(52) U.S. Cl. CPC G02B 1/18; B32B 2551/00; B32B 9/007; B32B 27/28; G02B 2006/12138; B32B 2264/102; B32B 2264/108; B32B 2305/55; B32B 2307/302; B32B 2307/412; B32B 2307/704; B32B 2307/754; B32B 2313/04; B32B 2311/16; G02B 6/12

(57) ABSTRACT

Systems, methods and devices to inhibit sensing reduction in imperfect sensing conditions are described. A multifunctional coating superposing a lens includes a self-cleaning layer and a heating layer. The self-cleaning layer defines an external surface configured to be exposed to an exterior environment. The external surface defines three-dimensional surface features thereon. The three-dimensional surface features are adjacently disposed arcuate features that inhibit adhering of solid particles to the external surface and wetting of the external surface. The heating layer is in thermal communication with the external surface. The heating layer is selectively actuated to provide thermal energy to the external surface through resistive heating. Each of the self-cleaning layer and the heating layer is transparent to a predetermined wavelength of light.

### INTRODUCTION

The disclosure relates to the field of lens coatings and, more specifically, to systems and methods for smart multifunctional lens coatings for use in, for example, vehicular applications.

Image light sensors include external surfaces such as lenses or transparent panes that provide passage of light from the external environment to the image light sensor. These external surfaces are susceptible to deposit of foreign objects thereon, which may obscure capture of the light from the external environment. This reduces sensing capability of the image light sensor. For example, water droplets deposited on the external surface may obscure locations of light sources and observed perimeters of objects. Further, ice or dirt may alter focal distances or otherwise occlude view of objects in the external environment.

Certain mechanical measures are used to remediate deposit of the foreign objects. For example, use of fluid jets directed at the external surface to remove the debris, which may then be followed by an intervention such as a wiper or directed airflow to remove the fluid. However, such mechanical measures increase the number of components used, increase vehicle weight, and occupy an amount of space to accommodate pumps, nozzles, piping, etc.

### SUMMARY

It is desirable to provide image light sensors that inhibit sensing reduction in imperfect sensing conditions. Systems and methods herein provide multifunctional coatings on external surfaces of image light sensors to optimize image capture in imperfect sensing conditions. These imperfect conditions may include the presence of rain, dust, road spray, ice, surface condensation (fogging), combinations thereof, and the like.

According to aspects of the present disclosure, a multifunctional coating superposing a lens includes a self-cleaning layer and a heating layer. The self-cleaning layer defines an external surface configured to be exposed to an exterior environment. The external surface defines three-dimensional surface features thereon. The three-dimensional surface features are adjacently disposed arcuate features that inhibit adhering of solid particles to the external surface and wetting of the external surface. The heating layer is in thermal communication with the external surface. The heating layer is selectively actuated to provide thermal energy to the external surface through resistive heating. Each of the self-cleaning layer and the heating layer is transparent to a predetermined wavelength of light.

According to further aspects of the present disclosure, the three-dimensional surface features form a micro-lens array to expand a field of view of the lens.

According to further aspects of the present disclosure, the three-dimensional surface features further include a film thereon, and the film includes fluorine.

According to further aspects of the present disclosure, the three-dimensional surface features are nanoscale structures formed from a crystalline material.

According to further aspects of the present disclosure, the crystalline material is diamond, silica, titanic, alumina, or a combination thereof.

According to further aspects of the present disclosure, the crystalline material is ultrananocrystalline diamond.

According to further aspects of the present disclosure, the three-dimensional surface features include a surface modifying agent selected from the group consisting of fluorine, fluorine-containing compounds, and fluorine-containing oligomers or polymers.

According to further aspects of the present disclosure, the heating layer includes a conductive polymer therein.

According to further aspects of the present disclosure, the heating layer includes single-walled carbon nanotubes or single-layer graphene.

According to further aspects of the present disclosure, the heating layer includes a conductive oxide.

According to further aspects of the present disclosure, the conductive oxide is indium tin oxide.

According to further aspects of the present disclosure, the conductive layer includes conductive metal wires.

According to further aspects of the present disclosure, the multifunctional coating further includes a light-control layer configured to inhibit transmission of one or more wavelengths of light in response to selective actuation.

According to further aspects of the present disclosure, the light-control layer includes a first state that allows transmission of predetermined wavelengths of light and a second state that prevents transmission of at least a portion of the predetermined wavelengths of light, and actuation of the second state occurs in response to receipt of a predetermined electrical signal.

According to further aspects of the present disclosure, the light-control layer includes one or more tungsten oxides (WOₓ), niobium oxides (NbOₓ), or liquid crystals.

According to aspects of the present disclosure, a system includes a lens, an image capture device, and a multifunctional coating. The image capture device is configured to receive predetermined wavelengths of light. The multifunctional coating is disposed on a side of the lens opposite the image capture device. The multifunctional coating includes a self-cleaning layer and a heating layer. The self-cleaning layer defines an external surface configured to be exposed to an exterior environment. The external surface defines three-dimensional surface features thereon. The three-dimensional surface features are adjacently disposed arcuate features that inhibit adhering of solid particles to the external surface and wetting of the external surface. The heating layer is in thermal communication with the external surface. The heating layer is selectively actuated to provide thermal energy to the external surface through resistive heating. Each of the self-cleaning layer and the heating layer are transparent to the predetermined wavelengths of light.

According to further aspects of the present disclosure, the three-dimensional surface features include a surface modifying agent selected from the group consisting of fluorine, fluorine-containing compounds, and fluorine-containing oligomers or polymers.

According to further aspects of the present disclosure, the system further includes a temperature sensor configured to determine a temperature of the external surface and a controller configured to selectively actuate the heating layer in response to the temperature being below a predetermined level to thereby increase the temperature to above the predetermined level.

According to further aspects of the present disclosure, the multifunctional coating further includes a light-control layer configured to inhibit transmission of one or more wavelengths of light in response to selective actuation.

According to further aspects of the present disclosure, the system further includes a light sensor configured to detect a lighting condition of the external surface and a controller configured to selectively actuate the light-control layer to thereby inhibit the transmission of one or more wavelengths of light in response to selective actuation.

According to further aspects of the present disclosure, the light-control layer includes one or more tungsten oxides (WOₓ), niobium oxides (NbOₓ), or liquid crystals.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

The drawings are illustrative and not intended to limit the subject matter defined by the claims. Exemplary aspects are discussed in the following detailed description and shown in the accompanying drawings in which:

FIG. 1 is a schematic illustration of a system for detecting light having a multifunctional coating, according to aspects of the present disclosure;

FIG. 2 is a schematic illustration of a lens with an abutting multifunctional coating, according to aspects of the present disclosure; and

FIG. 3 is a schematic illustration of a control mechanism, according to aspects of the present disclosure.

### DETAILED DESCRIPTION

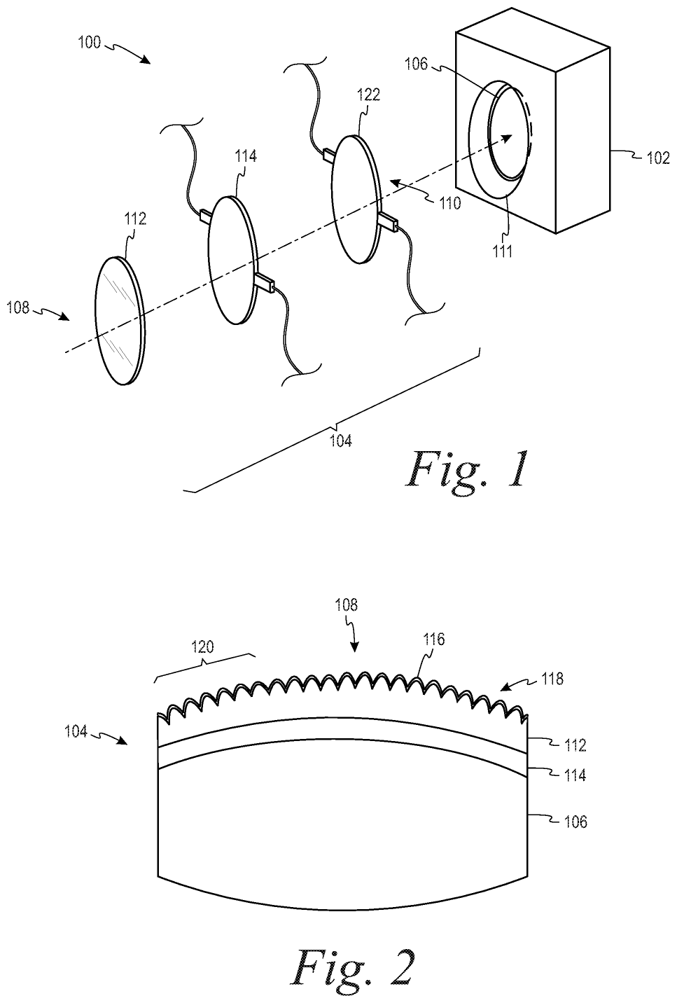

Referring now to FIG. 1, a system 100 for detecting light is shown. The system 100 includes an image capture device 102, a multifunctional coating 104, and a lens 106 disposed therebetween. The lens 106 superposes the image capture device 102 and is configured to receive light from an external environment and direct the received light onto an active portion, such as a charge-coupled device, of the image capture device 102. The lens 106 may be disposed adjacent the active portion of the image capture device 102, or may be spaced a distance from the active portion.

The active portion of the image capture device 102 is configured to receive light from the lens 106 and produce signals that provide indicia of properties for the received light. The signals may be, for example, electrical signals or digital data. The sensed properties of the received light may include wavelengths, intensity, polarization, spatial location, combinations thereof, and the like. The image capture device 102 may be a suitable device such as a camera, a charge coupled device, LiDAR, RADAR, etc.

The multifunctional coating 104 provides a plurality of functions to optimize the viewing and/or sensing capability of the image capture device 102. The multifunctional coating 104 includes an external surface 108 and an internal surface 110. The external surface 108 is exposed to debris, precipitation, and/or objects present in the ambient environment. The multifunctional coating 104 may be disposed within an aperture 111 on the surface of the image capture device 102 such that the external surface 108 is flush with a surface of the image capture device 102. In some aspects, the external surface 108 may be proud or shy of the surface of the image capture device 102. The internal surface 110 of the multifunctional coating 104 may abut the lens 106 or may be spaced a distance away from the lens 106. When the internal surface 110 is disposed a distance from the lens 106, the intervening space may include a void and/or additional components.

Referring now to FIG. 2, a lens 106 with an abutting multifunctional coating 104 is shown. The multifunctional coating 104 further includes a self-cleaning layer 112 defining the external surface 108 and a heating layer 114 that is in thermal communication with the external surface 108. The self-cleaning layer 112 is configured to inhibit accumulation of material on the external surface 108 of the system 100.

The external surface 108 may include a film 116 disposed on a substrate, define three-dimensional surface features 118, or both. In some aspects, the substrate defines the three-dimensional surface features 118 and the film 116 generally conforms to the three-dimensional surface features 118. In some aspects, the film 116 defines three-dimensional surface features 118 that are different from surface features of the substrate.

The film 116 is configured to reduce the surface energy of the external surface 108 relative to the surface energy of the underlying substrate. The film 116 may be formed by known methods such as depositing a chemical solution onto a substrate to thereby form the film 116 or treating a substrate with a surface modifying agent configured to react with the substrate. In some aspects, the surface energy is below 50 dynes/cm. More preferably, the surface energy is below 20 dynes/cm.

In some aspects, the film 116 and/or substrate are a polymeric material. The polymeric material may include at least one surface-modifying agent that modifies properties of the bulk polymeric material. For example, the polymeric material may include a polymeric backbone with surface-modifying agents that are selected to be thermodynamically drawn to the external surface 108 during application of the film 116. The surface-modifying agents may be reacted into the polymer backbone such that the agents cannot migrate or evaporate out of the film 116. In some aspects, the polymeric material is a fluorine-containing polymer. In some aspects, the surface-modifying agent is fluorine, a fluorine-containing compound, a fluorine-containing oligomer, or a fluorine-containing polymer.

In some aspects, the film 116 and/or substrate are a crystalline material. The crystalline material may include at least one surface-modifying agent that modifies properties of the bulk crystalline material. For example, the crystalline material may include surface-modifying agents dispersed throughout the crystalline material, concentrated proximate the external surface 108 of the crystalline material, or disposed on the external surface 108 of the crystalline material. The crystalline material may be forms of diamond including ultrananocrystalline diamond or diamond-like carbon, silica, titania, alumina, combinations thereof, and the like.

The three-dimensional surface features 118 are configured to inhibit aggregation of debris on the external surface 108. The three-dimensional surface features 118 may be a nanostructured pattern of a suitable geometry. In some aspects, the three-dimensional surface features 118 include a plurality of adjacently disposed arcuate features that inhibit adhering of solid particles to the external surface 108 and/or wetting of the external surface 108 by liquids such as water. In some aspects, a hydrophobic surface is provided by geometry of the three-dimensional surface features 118 and/or by chemistry of the film 116.

The three-dimensional surface features 118 may be additionally or alternatively configured to cooperate with the lens 106 to manipulate the light received by the image capture device 102. For example, the three-dimensional surface features 118 may form a micro-lens array 120 to expand the field of view for the system 100 when compared to a lens 106 without the multifunctional coating 104.

The heating layer 114 is configured to be selectively actuated to increase the temperature of the external surface 108, thereby inhibiting formation and/or promoting removal of fog and ice on the external surface 108. The heating layer 114 includes a material that is electrically conductive. The heating layer 114 is selectively actuated by passing an electrical current through the material to thereby provide resistive heating to the external surface 108. Providing thermal energy to the external surface 108 thereby provides defogging and/or de-icing capability. In some aspects, the material includes one or more metal wires. The wire or wires include a narrow cross-section along a path of light and are spaced a distance apart from an adjacent wire or loop to optimize light paths through the heating layer 114 such that an image of the object may still be received by the image capture device 102. In some aspects, the material is a conductive polymer. In some aspects, the material is a conductive oxide such as indium tin oxide. In some aspects, the material is a carbon-based material such as single-walled carbon nanotubes or single-layer graphene. For example, applying a voltage of about 110V to a substantially transparent film containing single-walled carbon nanotubes having an iron content of less than 1% and G/D ratio >100 may produce a temperature increase of about 80° C. in a few seconds.

The multifunctional coating may further include a light-control layer 122. The light-control layer 122 is selectively actuated to inhibit transmission of one or more wavelengths of light through the light-control layer 122. The transmission may be inhibited through an electronic change and or structural change to materials within the light-control layer 122.

The light-control layer 122 may include electrochromic elements, photoelectric elements, and/or photoelectrochromic elements. In some aspects, the light-control layer 122 may include one or more tungsten oxides (WOₓ), niobium oxides (NbOₓ), or liquid crystals.

The light-control layer 122 may be actuated by passing or inducing a current through the light-control layer 122.

The light-control layer 122 includes at least two states to provide selective transmission, reflection, or reduction of one or more predetermined categories or predetermined wavelengths of light. For example, a first state may be substantially transparent to both infrared and visible light, a second state may be substantially opaque to infrared light and substantially transparent to visible light, a third state may be substantially opaque to infrared light and partially transmissive to visible light, and a fourth state may be substantially transparent to infrared light and substantially opaque to visible light. As used herein, the term “partially transmissive” means that a predetermined amount of input light is transmitted through the material while the remaining amount of input light is either reflected or absorbed by the material.

Each state includes a signal associated therewith, and the light-control layer 122 may be transitioned between states by providing the respective signal. The signals may be a predetermined voltage, a predetermined current, a predetermined frequency of electrical energy, a predetermine magnetic field, combinations thereof, and the like. For example, the light-control layer 122 may be in a first state when no current is applied, a second state when a first voltage is applied, and a third state when a second voltage is applied.

the light-control layer 122 in a first state is substantially transparent to infrared light, visible light, and ultraviolet light, but substantially transparent to solely visible light while in the second state. In another example, the light-control layer 122 may be substantially transparent to light

Each layer is transparent or substantially transparent to desired wavelengths of light. As used herein, “transparent” means that at least one desired wavelength of light passes through the material from the external environment to the image capture device 102. The layers may be transparent to infrared light, visible light, ultraviolet light, single wavelengths, multiple single wavelengths, subsets thereof, combinations thereof, and the like. For example, if the image capture device 102 is configured to detect infrared light, the layers may be substantially transparent to the infrared spectrum, but one or more may be opaque to the visible spectrum.

The multifunctional coating 104 may be a unitary structure with domains of the above-described layers, a plurality of discrete layers that are abutting, a plurality of discrete layers that are spaced apart from each other, or combinations thereof.

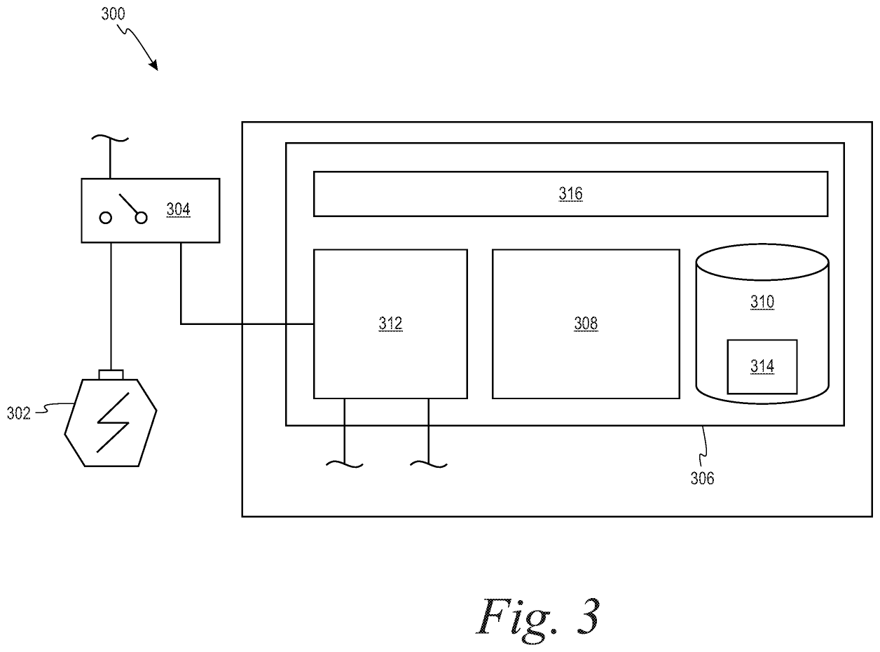

Referring now to FIG. 3, a subsystem 300 for use with the system 100 is shown. The subsystem 300 includes a voltage source 302, a switching mechanism 304, and a controller 306. The voltage source 302 is configured to supply electrical energy to the system 100. The switching mechanism 304 is configured to be selectively actuated to control the amount and/or timing of voltage being provided to various parts of the system 100 and/or multifunctional coating 104.

Although connections are not shown between all of the components illustrated in FIG. 3, the components can interact with each other to carry out system functions. For example, the controller 306 may be further configured to receive or send signals to the system 100 without passing through the switching mechanism 304.

The controller 306 may include hardware elements such as a processor 308, memory 310, circuitry including but not limited to a timer, oscillator, analog-to-digital (A/D) circuitry, digital-to-analog (D/A) circuitry, a digital signal processor, and input/output (I/O) devices 312 and other signal conditioning and/or buffer circuitry. The memory 310 may include tangible, non-transitory memory 310 such as read-only memory (ROM), e.g., magnetic, solid-state/flash, and/or optical memory, as well as sufficient amounts of random access memory (RAM), electrically-erasable programmable read-only memory (EEPROM), and the like. The memory 310 may include computer-readable instructions 314. The hardware elements are connected via a communication link 316, such as a system bus.

The system 100 may further include one or more environmental sensors such as a temperature sensor or a light sensor. The temperature sensor is configured to determine a temperature of the external surface 108. The determination may be made by directly sensing the temperature of the external surface 108 or may determine an environmental temperature that is correlated to the temperature of the external surface 108. The light sensor is configured to detect a lighting condition of the external surface 108. The light sensor may be disposed proximate the external surface 108 or may detect an environmental lighting condition that is correlated to the lighting condition of the external surface 108.

The system 100 may be integrated into a system for capturing images where a self-cleaning surface is desired, including a vehicle, a mobile device, production equipment, and the like.

While the best modes for carrying out the disclosure have been described in detail, those familiar with the art to which this disclosure relates will recognize various alternative designs and embodiments for practicing the disclosure within the scope of the appended claims.

What is claimed is:

1. A multifunctional coating superposing a lens, the multifunctional coating comprising:
a self-cleaning layer defining an external surface configured to be exposed to an exterior environment, the external surface defining three-dimensional surface features thereon, the three-dimensional surface features being adjacently disposed arcuate features that inhibit adhering of solid particles to the external surface and wetting of the external surface; and
a heating layer in thermal communication with the external surface, the heating layer being selectively actuated to provide thermal energy to the external surface through resistive heating,
wherein each of the self-cleaning layer and the heating layer is transparent to a predetermined wavelength of light.

2. The multifunctional coating of claim 1, wherein the three-dimensional surface features form a micro-lens array to expand a field of view of the lens.

3. The multifunctional coating of claim 1, wherein the three-dimensional surface features further include a film thereon, the film including fluorine.

4. The multifunctional coating of claim 1, wherein the three-dimensional surface features are nanoscale structures formed from a crystalline material.

5. The multifunctional coating of claim 4, wherein the crystalline material is diamond, silica, titania, alumina, or a combination thereof.

6. The multifunctional coating of claim 4, wherein the crystalline material is ultrananocrystalline diamond.

7. The multifunctional coating of claim 1, wherein the three-dimensional surface features include a surface modifying agent selected from the group consisting of fluorine, fluorine-containing compounds, and fluorine-containing oligomers.

8. The multifunctional coating of claim 1, wherein the heating layer includes a conductive polymer therein.

9. The multifunctional coating of claim 1, wherein the heating layer includes single-walled carbon nanotubes or single-layer graphene.

10. The multifunctional coating of claim 1, wherein the heating layer includes a conductive oxide.

11. The multifunctional coating of claim 10, wherein the conductive oxide is indium tin oxide.

12. The multifunctional coating of claim 1, further comprising a light-control layer configured to inhibit transmission of one or more wavelengths of light in response to selective actuation.

13. The multifunctional coating of claim 12, wherein the light-control layer includes a first state that allows transmission of predetermined wavelengths of light and a second state that prevents transmission of at least a portion of the predetermined wavelengths of light, and wherein actuation of the second state occurs in response to receipt of a predetermined electrical signal.

14. The multifunctional coating of claim 12, wherein the light-control layer includes one or more tungsten oxides (WOₓ), niobium oxides (NbOₓ), or liquid crystals.

15. A system comprising:
a lens;
an image capture device configured to receive predetermined wavelengths of light; and
a multifunctional coating disposed on a side of the lens opposite the image capture device, the multifunctional coating including:
a self-cleaning layer defining an external surface configured to be exposed to an exterior environment, the external surface defining three-dimensional surface features thereon, the three-dimensional surface features being adjacently disposed arcuate features that inhibit adhering of solid particles to the external surface and wetting of the external surface, and
a heating layer in thermal communication with the external surface, the heating layer being selectively actuated to provide thermal energy to the external surface through resistive heating,
wherein each of the self-cleaning layer and the heating layer are transparent to the predetermined wavelengths of light.

16. The system of claim 15, wherein the three-dimensional surface features include a surface modifying agent selected from the group consisting of fluorine, fluorine-containing compounds, and fluorine-containing oligomers.

17. The system of claim 15, further comprising:
a temperature sensor configured to determine a temperature of the external surface; and
a controller configured to selectively actuate the heating layer in response to the temperature being below a predetermined level to thereby increase the temperature to above the predetermined level.

18. The system of claim 15, wherein the multifunctional coating further includes a light-control layer configured to inhibit transmission of one or more wavelengths of light in response to selective actuation.

19. The system of claim 18, further comprising:
a light sensor configured to detect a lighting condition of the external surface; and
a controller configured to selectively actuate the light-control layer to thereby inhibit the transmission of one or more wavelengths of light in response to selective actuation.

20. The system of claim 18, wherein the light-control layer includes one or more tungsten oxides (WOₓ), niobium oxides (NbOₓ), or liquid crystals.
